(19) United States
(12) Patent Application Publication
(10) Pub. No.: US 2011/0177450 A1
(43) Pub. Date: Jul. 21, 2011

(54) TONER IMAGE FIXING METHOD

(75) Inventors: Eiji Uekawa, Susono-shi (JP); Masuo Yamazaki, Yokohama-shi (JP); Koichi Terauchi, Mishima-shi (JP); Katsuhiko Nishimura, Yokohama-shi (JP); Yukihide Ushio, Mishima-shi (JP); Ken-ichi Matsumoto, Tokyo (JP)

(73) Assignee: CANON KABUSHIKI KAISHA, Tokyo (JP)

(21) Appl. No.: 13/010,729

(22) Filed: Jan. 20, 2011

Related U.S. Application Data
(63) Continuation of application No. PCT/JP2010/065858, filed on Sep. 14, 2010.

(30) Foreign Application Priority Data
Sep. 17, 2009 (JP) 2009-215759

(51) Int. Cl. G03G 13/20

(52) U.S. Cl. 430/124.22

(57) ABSTRACT

A toner image fixing method reduces energy consumed in a fixing step in an electrophotographic image forming apparatus. A photopolymerization composition is coated on an unfixed toner image formed on a recording medium. Then, the photopolymerization composition is irradiated with light, which does not have an emission wavelength band in a far infrared range and which has a maximum emission wavelength of 360 nm or longer to 420 nm or shorter, by using an LED, whereby the photopolymerization composition is cured and the unfixed toner image is fixed to the recording medium.

### CROSS-REFERENCE TO RELATED APPLICATIONS

This application is a Continuation of International Patent Application No. PCT/JP2010/065858, filed Sep. 14, 2010, which claims the benefit of Japanese Patent Application No. 2009-215759, filed Sep. 17, 2009, both of which are hereby incorporated by reference herein in their entirety.

### TECHNICAL FIELD

The present invention relates to a toner image fixing method for fixing a toner image, which is formed on a recording medium and is unfixed, to the recording medium.

### BACKGROUND ART

Recently, TEC (Typical Electricity Consumption) set according to the International Energy Star Program as a scale for labeling energy savings of electrophotographic products has been widely spread over the world. A TEC value of a certain product is defined as an amount of electricity (kWH/Week) consumed in one week (168 hours), which is obtained by totalizing power consumptions in five working days and two holidays on condition that a job printing a specified number of sheets is performed a specified number of times at a nominal speed and at intervals of 15 minutes. Before 2007 when the application of the TEC was started, in most products, a large part of the TEC value had been occupied by, instead of total energy consumed in a printing time based on about 30 sec/job, energy consumed in the standby time (i.e., ready mode) and in the night and the holidays (i.e., sleep mode) other than the job.

Such a situation has changed in 2009. Now, in many products, the sleep mode is started in about one minute after the end of printing. The sleep-mode power in the so-called top-running products is reduced to a value as low as close to a limit, i.e., 1 W. The provision regarding a recovery time (not longer than 30 sec) from the sleep mode, which was stipulated according to the International Energy Star Program (targeted only for monochromatic copying machines and multifunction printers) before adoption of the TEC, has been abolished with spreading of application targets to printers, etc. connected to networks. As a result, it has become general to shorten the ready mode to the limit and to start printing from the sleep mode. During a period after 2009, the TEC value has been remarkably reduced, but the recovery time of 20 to 30 sec per job has been needed in many products. Thus, usability has been sacrificed in another aspect of view.

A remarkable reduction of the TEC value in these two years is apparent from the fact that the top-running TEC value of a multifunction printer with a speed of 35 color prints per minute was 2.5 kWh/week in 2007 in a high-end machine, while the top-running TEC value thereof has been reduced to 1.7 kWh/week in 2009. Also, in a printer as a low-end machine with a speed of 20 monochrome prints per minute, the top-running TEC value was 1.0 kWh/week in 2007, while the top-running TEC value has been reduced to 0.6 kWh/week in 2009. The top-running sleep-mode power in each of a color multifunction printer and a monochrome printer in 2009 is 1 W, and sleep-mode energy occupying in the TEC value is just 0.2 kWh/week at maximum in any of the color multifunction printer and the monochrome printer. When trying to further reduce the TEC value, there is no way other than reducing the power consumption during the printing, which occupies a large part of the TEC value. This is more serious problem in the high-end machine in which printing energy occupies a larger proportion of the TEC value. In printers of the heat-fixing (fusing) type, a further reduction of the temperature in fixing toner is considered as only one energy-saving measure that is left as being practically feasible. However, the further reduction of the temperature in fixing toner accompanies with a high difficulty due to a possibility that the toner may be accidentally fixed during transport and use. It is expected that, if the temperature in fixing toner is further reduced, its contribution to energy saving is just about 10%. For that reason, drastic energy saving is demanded which utilizes a fixing method without using heat. Attention is focused on an optical fixing method as one candidate of the fixing method without using heat. Main known optical fixing techniques will be described below.

Patent Literature (PTL) 1 discloses a digital printing unit that a coating composition is coated over a molten toner image and the coating is then irradiated with an ultraviolet ray through a transparent film to be cured, for the purpose of obtaining a toner image like an offset print, which is superior in resistance against scratching, wear and weather, and which has a high gloss. A step of peeling off the transparent film is also preformed, as required. Anyway, the digital printing unit disclosed in PTL 1 is used to form a protective film on the molten toner image and is practiced as a post-processing device (finisher) after fixing the toner to enhance a value of an electrophotographic image. Further, the digital printing unit disclosed in PTL 1 substantially requires a fixing step to be performed twice because an image having been obtained by fixing toner to a fixing target with application of a large amount of thermal energy in advance is further irradiated with an ultraviolet ray to perform optical curing. Accordingly, the disclosed solution still has a considerable problem from the viewpoint of energy saving.

PTL 2 relates to an image forming method for enhancing resistance against wear and scratching by forming a polymer coating, which has a three-dimensional cross-linked structure, on a toner image having been formed by an electrophotographic process. More specifically, a polymer coating composition contains, as essential ingredients, the following compounds (1) and (2). The compound (1) is either a combination of siloxy-denatured polycarbinol and acrylurethane or siloxy-denatured acrylurethane, and the compound (2) is a multifunctional acrylate compound. Further, according to PTL 2, the polymer coating composition causes toner to be cured and joined to an image support. The specification of PTL 2 states that the “curing” can be performed with only polymerization under application of heat or in combination with irradiation of light as the occasion requires. The essence of the invention disclosed in PTL 2 resides in using a substance called a “silicon-based compound”. A curable composition containing such a substance is cured by using, as a polymerization initiator, a benzophenone-based compound. The photopolymerization initiator used in an embodiment disclosed in PTL2 is effective in photo-curing performed by using a high-pressure mercury lamp that has an emission wavelength band in a far-infrared range as well, but it does not have a strong absorption spectrum within an emission spectrum range of LED-UV light that has no emission wavelength band in the far-infrared range. In other words, the disclosed photopolymerization initiator has very low sensitivity for the LED-UV light, thus resulting in a very low polymerization rate. Further, power consumption of the high-pressure mercury lamp used in the first embodiment of PTL 2 is very high, i.e., 118 W/cm. This implies that PTL 2 is also quite unsuitable for energy saving in the fixing step as with PTL 1.

PTL 3 relates to a coating composition to improve resistance against scratching and a non-tack (non-adhesive) property by coating a light-transparent polymer film on a toner image, which has been formed by an electrographic process in advance, for the purpose of realizing better persistence quality of an image. According to PTL 3, the “toner image, which has been formed by an electrographic process” is defined as a toner print that has been obtained through steps of development, transfer and fixing, and the fixing step is practiced as by utilizing, e.g., flash fixing, heat fixing (fusing), pressure fixing, and vapor fixing. Methods for covering a fixed toner image are already known, including a method of covercoating a photo print, as reported in many patents. Patents regarding various materials for use in the methods for covering the fixed toner image are also made open to the public. However, a group of those patents is not suitable for a measure to realize energy saving in the fixing step for the reason that a photopolymerization composition is coated on a previously fixed image in any of those patents.

PTL 4 discloses, in addition to a fixing method using, e.g., hot air, a fixing method for fixing not only toner particles together, but also toner and a recording medium to each other through the steps of preparing, as a photopolymerization composition, a liquid composition that is obtained by dissolving an unsaturated polyester resin in a vinyl monomer, coating the liquid composition on a recording medium, on which an unfixed toner image is formed, by using a plurality of nozzles, for example, and curing the coated liquid composition with irradiation of an ultraviolet ray. PTL 4 mentions energy saving as an effect of the fixing step using the liquid composition. However, the energy saving effect is explained in PTL 4 just by the expressions that the toner image “could be fixed with less fixing energy” by the hot-air drying, and that the toner image “could be fixed with less fixing energy by irradiating the ultraviolet ray with an ultraviolet lamp”. However, the energy saving effect is not proved by referring to features of the ultraviolet source and values of power consumption in detail. In other words, it is questionable that a currently-demanded level of energy saving is satisfied just by using the ultraviolet ray for the fixing on the basis of energy saving at the same level as that achievable when a heater utilizing heat is employed. Further, no reference is made on a waiting time, such as a rising time of an ultraviolet lamp, with respect to not only the above-mentioned fixing methods, but also other fixing methods mentioned in PTL 4. It is easily estimated that, for example, when the heater is employed, a certain waiting time is generated depending on characteristics of the heater. This is similarly applied to the case of using the ultraviolet lamp.

Further, the photopolymerization composition used in PTL 4 requires to be supplied from the non-image side, i.e., the rear side, of the recording medium by using a supply roll in such a manner that the photopolymerization composition is strongly penetrated (permeated) through the recording medium until reaching the toner image formed on the front surface of the recording medium. To meet such a requirement, components of the photopolymerization composition include a surfactant as a penetration accelerant. However, the addition of the surfactant causes the photopolymerization composition to strongly penetrate into the deep of the recording medium. Moreover, the photopolymerization composition has to be applied in a large amount to the recording medium (e.g., plain paper). Thus, because the photopolymerization composition is caused to penetrate into fibers of the recording medium, light cannot sufficiently reach the insides of the fibers of the recording medium with ordinary irradiation of the ultraviolet ray. As a result, the photopolymerization reaction occurs insufficiently, whereby non-reacted monomers and oligomers having low vapor pressures are generated to increase an amount of volatile organic compounds (VOCs). Further, solids having been polymerized inside the fibers make the recording medium transparent and remarkably degrade the value of an image. Still another disadvantage is in that the polymerized solids increase rigidity of the recording medium to such an extent as providing a feeling different from that of the original plain paper for electrophotography. When coated paper is used as the recording medium in the invention disclosed in PTL 4, the penetration of the photopolymerization composition is blocked by a coating layer of the coated paper, and sufficient photopolymerization reaction is not expectable, thus leading to a difficulty in coating the toner image.

### Citation List

Patent Literature

PTL 1 Japanese Patent Laid-Open No. 2004-34688

PTL 2 U.S. Pat. No. 4,477,548

PTL 3 Japanese Patent Laid-Open No. 2009-096990

PTL 4 Japanese Patent No. 4014773

A problem to be solved by the present invention is to provide a toner image fixing method which can drastically reduce energy required to fix toner onto a recording medium in comparison with that required in known heat fixing (fusing) methods.

### SUMMARY OF INVENTION

To solve the above-described problem, the present invention provides a toner image fixing method comprising the steps of coating a photopolymerization composition on an unfixed toner image formed on a recording medium, and then irradiating the photopolymerization composition with light, which does not have an emission wavelength band in a far infrared range and which has a maximum emission wavelength in a range of 360 nm or longer to 420 nm or shorter, by using a light emitting diode or an organic EL element, thereby curing the photopolymerization composition with a photopolymerization reaction and fixing the unfixed toner image to the recording medium.

Further, the present invention provides a toner image fixing method comprising the steps of preparing a recording medium including an unfixed toner image of which surface is coated with a photopolymerization composition, and irradiating the recording medium with light, which does not substantially have an emission band in a far infrared range and which has a maximum emission wavelength in a range of 360 nm or longer to 420 nm or shorter, thereby causing the photopolymerization composition to develop a photopolymerization reaction and fixing the unfixed toner image to the recording medium.

Further features of the present invention will become apparent from the following description of exemplary embodiments with reference to the attached drawings.

### BRIEF DESCRIPTION OF DRAWINGS

FIG. 1 comparatively illustrates the gamut (color space) in each of EXAMPLE 1 and COMPARATIVE EXAMPLE 1.

FIG. 2 is a graph illustrating the relationship between an image density and a 75-degree gloss in each of EXAMPLE 1 and COMPARATIVE EXAMPLE 1.

FIG. 3 illustrates a coating method using a roll coater.

### DESCRIPTION OF EMBODIMENTS

With a toner image fixing method according to the present invention, a photopolymerization composition is coated on an unfixed toner image formed on a recording medium. Then, the photopolymerization composition is irradiated with light, which does not have an emission wavelength band in a far infrared range and which has a maximum emission wavelength in a range of 360 nm or longer to 420 nm or shorter, by using a light emitting diode or an organic EL element, whereby the photopolymerization composition is cured with a photopolymerization reaction and the unfixed toner image is fixed to the recording medium. In order to reduce electric power necessary for fixing the unfixed toner image, the following points are important. Namely, a light source for irradiating the photopolymerization composition with the light has high heat-generation efficiency in itself. The light source has a narrow emission wavelength band. The photopolymerization composition used herein is more apt to accelerate the polymerization reaction in the emission wavelength band of the light source. If the emission efficiency of the light source for irradiating the photopolymerization composition with the light is too low, the electric power necessary for fixing the unfixed toner image is increased. Therefore, the LED or the organic EL element each having the maximum emission wavelength of 360 nm or longer is preferable. Also, if the emission wavelength is longer, the energy applied to the photopolymerization composition is reduced. Therefore, the LED or the organic EL element each having the maximum emission wavelength of 420 or shorter is preferable. Stated another way, the light emitting diode or the organic EL element emitting the light, which does not have an emission wavelength band in a far infrared range and which has the maximum emission wavelength in a range of 360 nm or longer to 420 nm or shorter is preferable as the light source for irradiating the photopolymerization composition coated on the unfixed toner image with the light. In particular, the light emitting diode or the organic EL element emitting an ultraviolet ray is preferable.

The light emitting diode (LED) preferably has a chip configuration having high emission efficiency. When InGaN is utilized as a light emitting layer, the emission wavelength of the light emitting layer can be changed from an infrared range to an ultraviolet range by changing an In composition. More specifically, the In composition ratio needs to be reduced in order to fabricate the LED having the emission wavelength of 420 nm or shorter, but a reduction of the In composition ratio reduces the emission efficiency at the same time. The longer the emission wavelength, the higher is the emission efficiency of the LED. Conversely, the shorter the emission wavelength, the lower is the emission efficiency of the LED. Accordingly, the LED having the maximum emission wavelength of 360 nm or longer is preferable. As one example of LEDs having the emission wavelengths near 400 nm, an LED device exhibiting an output of 33 mW upon supply of 20 mA and having external quantum efficiency in excess of 50% is developed by appropriately designing unevenness of the In composition. The LED can be reduced in device size in comparison with various metal-halide light sources and medium- or high-pressure mercury lamps. Further, the LED is advantageous in that its brightness is momentarily raised with an on-off operation, and that it does not use mercury. Still further, an emission wavelength distribution of the LED is narrow and the LED does not generate ozone. Still further, the LED has no emission spectra in the visible range and the infrared range. Therefore, the LED generates heat in a small amount and has features friendly to environments from the viewpoint of energy saving. Also, higher emission efficiency is advantageous in that light emitting elements can be arranged on one line, instead of plural lines, in the sub-scanning direction, and that a light emitting unit provided with simple fins for radiating heat can be employed by arranging the light emitting elements in the form of an array in the main scanning direction. Desired emission intensity of the LED depends on sensitivity of the photopolymerization composition and a process speed in a main body of an electrophotographic image forming apparatus. Further, the desired emission intensity of the LED is largely affected by the distance from an emergent surface of the light emitting element to an irradiated surface (i.e., the work distance), the type of a light guide, the type of a condensing lens, the presence or the absence of a diffusion plate, etc. In general, light emitting elements having irradiation intensity of 400 mW/cm² or more to 2000 mW/cm² or less in the main scanning direction are primarily used. In this respect, it is not necessarily required to adjust light quantities emitted from the light emitting elements by precisely controlling current values supplied to the individual light emitting elements in an independent manner. Simplification and a cost reduction of a light source device may be obtained by controlling a current value for all the light emitting elements in a collective manner.

An LED device is manufactured by growing an epitaxial layer of an LED structure on a sapphire substrate under high vacuum based on a metal organic chemical vapor deposition (MOCVD) process. In contrast, an organic EL (OLED) device can be probably manufactured under the atmosphere by utilizing gravure printing or an ink jet coating process. In comparison with the LED, therefore, remarkable cost cutting is expected by using the OLED as the light emitting element. However, the currently available OLED is required to form a multilayer structure, including a hole injection layer, a hole transport layer, a luminescent layer, an electron transport layer, an electron injection layer, etc., on a glass substrate between a transparent anode, such as made of ITO, and a cathode under high vacuum. If a high-molecular luminescent substance soluble in a solvent becomes available, the layer configuration between both the electrodes can be preferably simplified. Using a phosphorescent material can also simplify the layer configuration and is advantageous in cutting the cost.

Further, because the organic EL (OLED) device is a surface emitting device, fabrication of a light emitting unit, including mounting of the OLED devices thereto, is much easier than the case of using the LED that is a point emitting device. More specifically, an OLED device emitting a near ultraviolet ray, having an emission half-width of 42 nm and a peak wavelength of 380 nm, can be obtained by employing, as a luminescent material, a triazole-based derivative, which has been proposed by Mizuno et al. (Kanazawa Institute of Technology), see “Singaku Gihou” (The Technical Report of the Proceeding of the Institute of Electronics, Information and Communication Engineers), vol 107, no 552, p5-8 (2008), and by combining the proposed derivative with a wide gap material, such as CBP, BCP or B-phen.

The photopolymerization composition can develop a polymerization reaction with three types of photopolymerization reactions. The first one is a radical photopolymerization reaction in which active radical species are formed upon irradiation of light to a photopolymerization initiator and the formed active radical species are successively polymerized with monomers, to thereby develop a growth reaction. The second one is a cation photopolymerization reaction in which active cation species are formed upon excitation of a photopolymerization initiator, such as a sulfonium salt or an iodonium salt, with irradiation of light and the formed active cation species are successively polymerized with monomers, such as epoxy compounds, oxetane compounds or vinyl ether compounds. The third one is an anion photopolymerization reaction in which active anion species generated upon excitation with irradiation of light take part in a polymerization reaction. Any type of those three reactions can be utilized. As the radical photopolymerization reaction, there are two types of reactions, i.e., the Norrish I type and the Norrish II type. In the Norrish I-type reaction, any of α-hydroxy ketones, α-amino ketones, BDK, MAPO, and BAPO is excited into a triplet state and is homolytically decomposed at α-positions to generate the active radical species. In the Norrish II-type reaction, benzophenone is excited into a triplet state with light excitation, and a hydrogen abstraction reaction is developed on tertiary amine in the excited triplet state to generate active radical species, which cause a photopolymerization reaction with monomers. The radical photopolymerization reaction is primarily employed because of the presence of abundant monomer species in spite of a tendency to impede reactions caused by oxygen. In order to effectively develop the photopolymerization reaction with LED light, it is necessary to employ a photopolymerization composition including a photopolymerization initiator that has an absorption spectrum well matched with an emission spectrum of the LED light. In particular, since the LED light has an emission spectrum band narrower than those of a metal halide lamp and a medium- or high-pressure mercury lamp, selection of the photopolymerization initiator is more important. Regarding practical examples of the radical photopolymerization initiator, phosphine-based compounds, imidazole-based compounds, ketal-based compounds, or thioxanthone-based compounds are used as typical initiators having absorption wavelengths in the range of 360 nm or longer to 420 nm or shorter.

A method for developing the photopolymerization needs to be designed such that the photopolymerization composition is polymerized at the surface of a recording medium while its penetration into the recording medium is minimized. There are several methods for photo-polymerizing the photopolymerization composition on the surface of the recording medium. Those methods are realized, for example, by mixing, in the photopolymerization composition, monomers or multifunctional monomers, which are highly sensitive to light.

Preferred examples of the monomers include mono-functional acryl-based monomers and multifunctional acryl-based monomers. The functional acryl-based monomers include bifunctional acryl-based monomers represented by tricyclodecane dimethylol diacrylate, bisphenol F (EO-denatured) diacrylate, bisphenol A (EO-denatured) diacrylate, polypropylene glycol diacrylate, and polyethylene glycol diacrylate, trifunctional acryl-based monomers represented by trimethylolpropane (PO-denatured) triacrylate, trimethylolpropane (EO-denatured) triacrylate, isocyanuric (EO-denatured) triacrylate, and ε-caprolactone-denatured tris(acroxyethyl) isocyanurate, tetrafunctional acryl-based monomers represented by pentaerythritol tetraacrylate and ditrimethylolpropane tetraacrylate, and penta- and hexa-functional monomers represented by dipentaerythritol pentaacrylate and dipentaerythritol hexaacrylate. Other preferred examples of the monomers include acryl-based olygomer compounds which are constituted by polyester acrylate, urethane acrylate and epoxy acrylate, and cation or anion polymerizable monomers which are constituted by epoxy resin, oxetane resin, and vinyl ether. From among the above-mentioned examples, selection of the multifunctional monomer as the acryl-based monomer is particularly important. The multifunctional monomer, particularly the tetra or more multifunctional monomer is an important constituent in point of causing a quick cross-linking reaction from the B-stage to the C-stage and contributing to an improvement of a fixing speed. Another major feature of the tetra or more multifunctional monomer resides in that it can be handled as being not a flammable liquid based on the advantage of developing the quick cross-linking reaction. Regarding additives, transparent additives, such as a sensitizer, a viscosity adjuster, and a fluidity adjuster, can be added in addition to the photopolymerization initiator, the monomers, and the oligomers. The fact that a substance obtained with the photopolymerization and the curing is colorless and transparent is important in improving color purity. A practical additive filler is selected from organic compounds or inorganic compounds each having a particle diameter on the nano order.

An optimum amount of the photopolymerization composition to be mixed depends on the roughness and density of the surface of the recording medium, but also the timing of light irradiation after coating the photopolymerization composition. The photopolymerization composition is preferably coated in an amount corresponding to a thickness of 1 μm or more to 20 μm or less. When a recording medium coated with a resin or a filler such as silica or aluminum oxide is used, it is preferable that the photopolymerization composition is coated in a small amount and a photo-cation polymerizable composition exhibiting a smaller cure shrinkage is employed. However, the photo-cation polymerizable composition is poor in stability in a state left to stand. For that reason, a photo-radical polymerizable composition is preferably selected. If the photopolymerization composition is coated in a thickness of larger than 20 μm, this is unsatisfactory in that the recording medium may be curled or may become transparent. If the photopolymerization composition is coated in a thickness of smaller than 1 μm, this is unsatisfactory in that the interlayer strength between the toner and the recording medium may be reduced and fixation performance may become insufficient, thus resulting in missing of the toner upon rubbing (friction), folding, etc.

A method for coating the photopolymerization composition is selected from among known methods for coating a medium- or low-viscosity substance into a thin layer. The coating can be performed by using, for example, a rod coater, gravure coater, a reverse gravure, a Mayer bar coater, a die coater, a kiss-roll coater, a one-fluid nozzle having a full-cone nozzle, a flat spray nozzle or a knife jet nozzle, a two-fluid nozzle, a roll coater, an electric-field atomization process, and an ink jet process. Usually, the photopolymerization composition is coated over the entire recording medium. However, the photopolymerization composition may be discharged only to a toner portion by moving a carriage holding an ink jet head in synchronism with each of image portions which are separately positioned corresponding to individual image areas.

Optimum viscosity of the photopolymerization composition depends on the coating method. The nozzle process and the ink jet process are highly preferable to control a very small discharge rate. However, those processes can be applied only to compositions having a comparatively low viscosity because a driving force of a piezoelectric element is low. More specifically, those processes can be applied only to compositions having a low viscosity of about 10 mPa·s or higher to about 30 mPa·s or lower in an environment at 25° C. On the other hand, the gravure coater, the roll coater, and the heating IJ (ink jet) process can be used to coat compositions having a comparatively wide range of viscosity. More specifically, those processes are suitable for compositions having a comparatively medium viscosity, i.e., a viscosity of about 30 mPa·s or higher to about 400 mPa·s or lower. The photopolymerization composition coated on the unfixed toner image is preferably photo-polymerized on the surface of the recording medium. From that point of view, the photopolymerization composition having a medium range of viscosity is particularly preferable rather than the photopolymerization composition of the penetration type having a low viscosity.

After the photopolymerization composition has been supplied to the toner surface and the surface of the recording medium, behaviors of the photopolymerization composition penetrating in the Z-direction, apart from diffusion in the X-Y directions, can be well understood based on the Lucas-Washburn's equation. As discussed in “Denshi Shashin Gakkaishi” (“Electrophotography”, The Society of Electrophotography of Japan), 37, 149 (1998), for example, a penetration distance in the Z-direction can be satisfactorily controlled by adjusting variables d, y, θ, η and t in the following equation;

Lucas-Washburn's equation: I=(d·t·y·cos θ/4η)^{1/2}

where I: penetration distance, d: capillary diameter, y: surface tension, θ: contact angle, η: viscosity, and t: time. The penetration distance I can be reduced by reducing a value of the numerator, for example, by reducing the surface tension of the photopolymerization composition and shortening the time from the coating to the irradiation of light. Meanwhile, the viscosity of the photopolymerization composition has to be increased to increase the denominator. The toner used in image formation is preferably filled at a density as high as possible without leaving a blank area of the recording medium so that a material color of the recording medium is concealed and the density of a colorant mixed in the toner is made conspicuous to the utmost. Further, because the heat fixing step is not employed at all, toner not mixed with a parting agent, which has been an essential constituent of the toner in the past, can also be employed in many cases. More specifically, when the photopolymerization composition is coated on a toner image formed in multiple layers on the recording medium, the photopolymerization composition in a liquid phase fills spaces among toner particles and penetrates deeply through the toner layers with a capillary effect while generating a strong cohesive force among the toner particles, thus finally reaching the recording medium. In order to maximally develop such a capillary effect, the toner particles preferably have uniform particle sizes and a spherical shape so that the closest filling effect is more apt to develop strongly. Further, in some cases, toner penetrability may be controlled by applying a voltage to an electrical double layer, which is formed by the surface of the toner in a solid phase and the photopolymerization composition in a liquid phase, to thereby generate an electro-osmotic flow. In the past, when using a heat-roll fixing device or a pressure fixing device, a parting agent, such as synthetic wax made of polyethylene or polypropylene, or polyalkylene wax, ester wax, polyamide wax, or montanoic wax, which is modified or refined from coal, plants or honey, has been always mixed in the toner to develop the effect of preventing the toner from being offset to a heating roller. However, the mixed parting agent may often contaminate the sleeve surface of a developing roller and the surface of a photosensitive drum. In addition, poor compatibility between a resin used in the toner and the parting agent may accumulate the parting agent in a developing device and may impede even dispersion of pigments during endurance use, thus eventually broadening a charge distribution of the toner and causing a factor to impede formation of a stable image. To cope with the problem mentioned above, many contrivances have been proposed hitherto. In contrast, since the present invention does not utilize a heat source in the fixing step, it becomes possible to completely omit the parting agent which has been mixed in the toner in the past, to replace heat-resistant members disposed around the fixing device with ordinary members made of general-purpose plastic materials, and to realize both stabilization of chargeability of the toner during endurance use and cost-cutting of the fixing device for the first time.

The toner made of particles having even sizes and the spherical shape can be produced by utilizing a well-known polymerization process. The toner made of particles having even sizes and the spherical shape is preferably produced by a method utilizing an interface tension in a liquid from the viewpoint of production energy and yield rather than a method of producing toner with a pulverization process in the atmosphere, which requires a large amount of pulverization energy. An in-situ polymerization process for producing toner directly from a monomer is preferably employed in consideration of productivity with satisfactory energy saving. For example, a known production method disclosed in Japanese Patent No. 03066943 can be employed. In toner obtained with the disclosed production method, however, a parting agent is mixed as an essential constituent in the toner and a core-shell structure is utilized to enclose the parting agent in a resin, to thereby minimize the drawback of the parting agent. Since the present invention can use toner containing no parting agent without needing the above-mentioned countermeasure, a kneading step is considerably facilitated and, in some cases, it may be omitted. This greatly contributes to reducing a production time and energy necessary for the production of the toner. While the in-situ polymerization process is optimum as the toner producing method from the viewpoint of production yield, production energy, and easiness in forming the spherical toner particles, the toner producing method is not limited to the polymerization process. Toner obtained with a pulverization process, i.e., toner produced by the pulverization process and then heat-treating the same into a spherical shape, can also be preferably employed.

The circularity of toner can be measured by using FPIA-3000 made by Sysmex Corporation. The circularity of toner can be expressed by the following formula:

Circularity=(circumferential length of circle having area equal to particle area)/(circumferential length of particle)

The circularity of toner was measured by adding 5 mg of the toner to 10 ml of water mixed with about 0.1 mg of nonionic surfactant, and thereafter dispersing the toner in the water for five minutes with an ultrasonic disperser. A value of the circularity is 1.00 in the case of a perfect true sphere, and it decreases as the toner has a more complicated shape. In particular, the toner having the circularity of 0.95 or more to 1.00 or less is preferably used.

A toner image after the fixing step, obtained with the present invention, has substantially the same gloss over a range from a low-density image area to a high-density image area and also has a wider gamut in the CIE L*a*b* space in comparison with a toner image obtained with the heat fixing process. Further, fixation performance, represented by resistance against rubbing (friction) and folding, of the toner image obtained with the present invention is comparable to that obtained with the heat fixing process. The reason is presumably in that the photopolymerization composition enters gaps between the toner surface and the particle boundary between adjacent toner particles, then positively reaches the recording medium, and is polymerized upon irradiation of light, thus smoothing the toner surface and preventing scattering of light at the interface provided by the particle boundary. As a result, a sufficient level of fixation performance can be developed while ensuring a wide gamut. Hitherto, it has been general that because the heat fixing step is carried out in a pressurized state, an area having a higher image density, i.e., an area having a higher toner density, exhibits a higher gloss, whereas an area having a lower image density exhibits a lower gloss. Thus, it has been difficult to obtain a comparatively uniform and proper gloss over the entire image surface. In the present invention, since photo-fixing is carried out, the surface of the image after the fixing is more apt to be uniformly smoothed anywhere. The uniform gloss improves quality of the image. Particularly, the uniform gloss is very preferable in presenting photograph-like prints and commercial prints including prints obtained with the so-called print on demand (POD).

The present invention will be described in more detail in connection with the following EXAMPLES.

### EXAMPLE 1

Cyan toner for use in EXAMPLE 1 was prepared as follows. 710 Parts by weight of ion exchanged water and 450 parts by weight of 0.1 mol/liter-Na₃PO₄ aqueous solution were put in a 2-liter four-necked flask provided with a high-speed stirrer called a TK-homomixer. After heating the mixture to 65° C., the number of revolutions of the stirrer was adjusted to 12000 rpm. A water-insoluble dispersion stabilizer Ca₃(PO₄)₂ was prepared by gradually adding 68 parts by weight of 1.0 mol/liter-CaCl₂ aqueous solution. On the other hand, a dispersoid system contained:

| | |
|---|---|
| Styrene monomer | 165 parts by weight |
| N-butyl acrylate monomer | 35 parts by weight |
| Cyan colorant (C.I. pigment blue 15:3) | 14 parts by weight |
| Polar resin [(terephthalic-propylene oxide | 10 parts by weight |
| denatured bisphenol A) polyester resin, acid | |
| number of 15, and peak molecular weight | |
| of 6000] | |
| Negative charging control agent (dialkylsalicylic | 2 parts by weight |
| metal compound) | |

A mixture of the above-mentioned components was dispersed for 10 minutes by using an attritor. A dispersing step could be completed in a dispersion time that was 1/6 of the dispersion time taken for a system including a departing agent. Thereafter, 10 parts by weight of 2,2′-azobis(2,4-dimethylvaleronitrile) was added as a photopolymerization initiator to prepare a polymerizable composition. The prepared polymerizable composition was gradually put into the water-based dispersion medium and subjected to high-speed stirring for 15 minutes with the number of revolutions of the stirrer maintained at 12000 rpm. Then, a polymerization reaction was continued for 10 hours by replacing the high-speed stirrer with a stirrer having propeller blades, raising an internal temperature from 65° C. to 80° C., and reducing the number of revolutions to 50 rpm. After the end of the polymerization, a diluted hydrochloric acid was added and the dispersion stabilizer was removed. Further, after washing with water, the obtained cyan toner was dried. The weight mean diameter of the cyan toner was 5.6 μm and the variation coefficient in number distribution was 23%. The circularity of the obtained cyan toner was 0.98. 2 Parts by weight of hydrophobic titanium oxide in the form of fine particles was added to 100 parts by weight of the obtained cyan toner, whereby cyan toner having good fluidity was obtained. In addition, electrically insulating yellow toner, magenta toner and black toner were obtained in a similar manner just by replacing the colorant with C.I. pigment yellow 17, C.I. pigment red 202, and graft carbon black, respectively. A developer was prepared by mixing 2% by weight of hydrophobic titanium oxide in the form of fine particles to each of the obtained yellow toner, magenta toner, and black toner as with the cyan toner.

An image forming apparatus was prepared by modifying a tandem color printer LBP5050 (made by Canon Kabushiki Kaisha), namely by removing a heat fixing device from the same. The one-component developer prepared for each color as described above was put in a developing device, and an unfixed toner image was formed on the recording medium. Letter-size plain paper made by Xx Company and having a basis weight of 75 g/m² was used as the recording medium.

As the photopolymerization composition, a stock solution with a viscosity of 27 mPa·s was prepared by mixing 80 parts by weight of dipropylene glycol diacrylate (bifunctional monomer), 10 parts by weight of trimethylolpropane ethoxytriacrylate (trifunctional monomer), 5 parts by weight of pentaerythritol ethoxytetraacrylate (made by Sartomer Company: tetrafunctional monomer), and 5 parts by weight of phenylbis-(2,4,6-trimethylbenzoyl)-phosphine oxide (photopolymerization initiator). The prepared stock solution was loaded in a large-size IJ machine UJF-605cII made by Mimaki Engineering Co., Ltd., and the photopolymerization composition was coated in an amount providing a thickness of 5 μm on the unfixed toner image which had been formed in advance by using the above-mentioned modified printer. The coating amount was determined by measuring the thickness of a coating film after coating the photopolymerization composition on a PET (polyethylene terephthalate) film as a control and photo-curing the coated photopolymerization composition.

An LED-UV (ultraviolet-ray emitting diode) having an emission peak wavelength (maximum emission wavelength) of 385 nm±5 nm and having no emission wavelength band in a far infrared range was used as a light irradiation device for irradiating the unfixed toner image, formed on the recording medium, with light. The number of LEDs was reduced by employing a cylindrical lens such that an irradiation area was adjusted in its direction to have an oblong shape.

The UV irradiation intensity of the LED in this EXAMPLE was 500 mW/cm² and such a level of the UV irradiation intensity was held over a width of 12 mm in the direction of a long axis and a width of 5 mm in the direction of a short axis. Twenty LEDs of that type were arranged in the form of an array with the long axis of each LED aligned with the main scanning direction, thus setting the irradiation area to cover a letter size width (215.9 mm). The LEDs were arrayed in one line in the sub-scanning direction. Because the power consumption per LED was 4 W, the power consumption in a full turning-on mode was 80 W in total. A heat sink measure was not particularly designed, and simple fins were just provided.

The above-described light irradiation device was installed on a belt conveyor and a photopolymerization rate was studied with a variable speed of the belt conveyor. The speed of the belt conveyor was changed to previously measure a speed at which adhesion on the surface of the cured film disappeared with exposure of light, and the toner image was fixed at the measured speed. The photopolymerization reaction was quickly progressed with a light irradiation time, i.e., an exposure time, of 0.1 sec and no problems occurred in regard of fixing performance. For example, no problems occurred with respect to offset (setoff) of the fixed toner image on one recording medium to the rear side of another one and a rubbing (friction) smear of the fixed toner image when many recording mediums were stacked in a tray.

Evaluation of an image was performed as follows. Measurement of L*a*b* was performed by using Spectrolino made by GretagMacbeth Company.

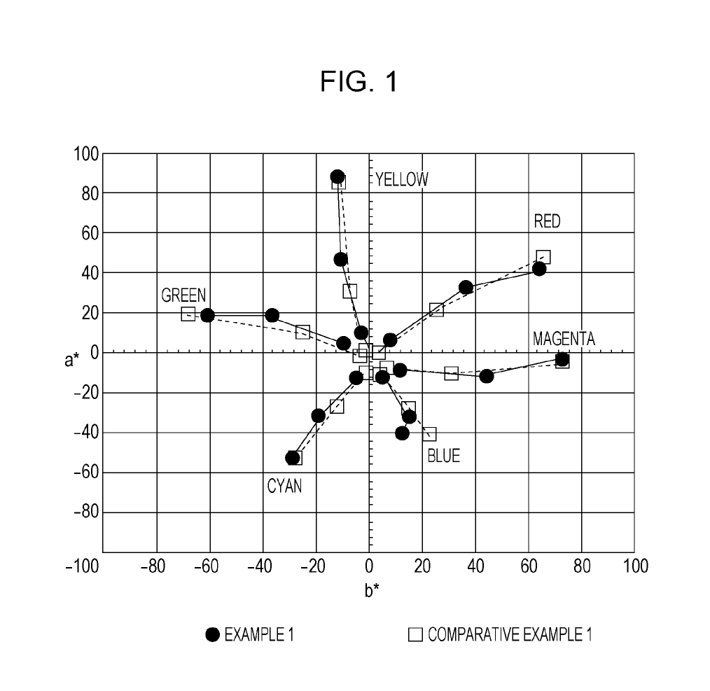

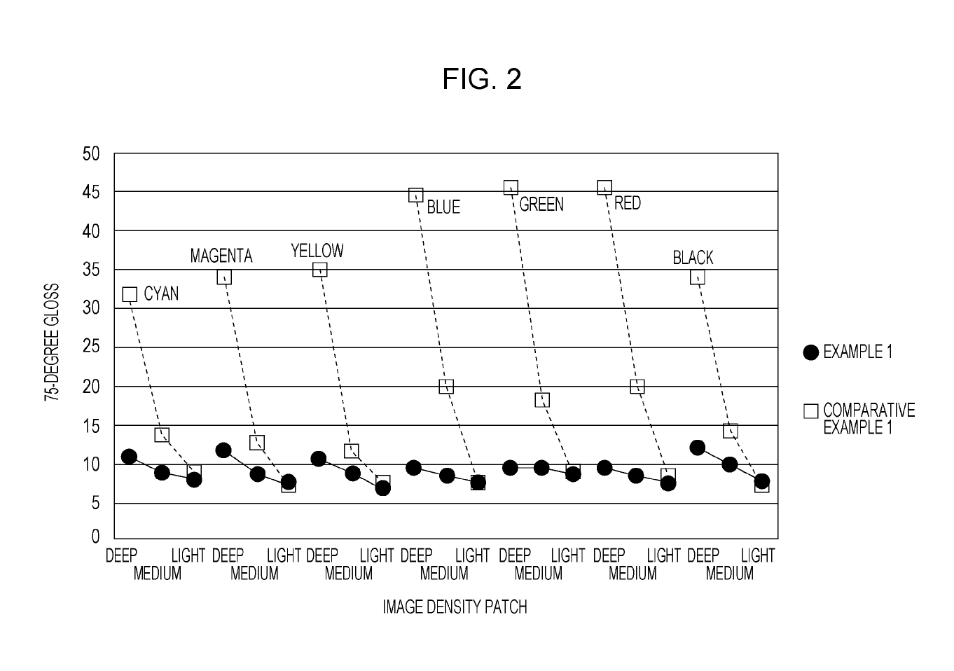

The measurement was performed on the following conditions; i.e., observation light source: D50, observation visual field: 2 degrees, density: ANSI A, white reference: Abs, and filter: No. Obtained results are shown in Table 1 and FIG. 1. Table 1 lists actually measured values of L*, a*, b*, C and h. Further, a relative saturation ratio (C_{EXAMPLE}/C_{COMPARATIVE EXAMPLE 1}) with respect to COMPARATIVE EXAMPLE 1 was measured, and a mean value of the saturation ratios in respective colors except for black was calculated as real ability representing the breadth of a dynamic range of an image sample formed in each of EXAMPLE 1 and other following EXAMPLES. FIG. 1 comparatively illustrates a color space (gamut) in each of EXAMPLE 1 and COMPARATIVE EXAMPLE 1. In FIG. 1, a mark represents EXAMPLE 1 and a mark □ represents COMPARATIVE EXAMPLE 1. A 75-degree gloss was measured by using VG200 made by Nippon Denshoku Industries Co., Ltd. Obtained results are shown in Table 2 and FIG. 2.

Evaluation of the image formed in EXAMPLE 1 was carried out in comparison with a toner image (COMPARATIVE EXAMPLE 1) which was output after carrying out a heat fixing process in LBP5050 equipped with the heat fixing device. Table 2 lists results of measuring the relationship between an image density and a gloss by using a grey chart with the density changed in three stages (deep, medium and light). As seen from Table 2 and FIG. 2, the image in EXAMPLE 1 has a substantially constant gloss of about 10 with respect to change of the density. In-plane image evenness is substantially constant in not only a primary color, but also a secondary color. On the other hand, the image in COMPARATIVE EXAMPLE 1 has a gloss largely depending on the image density, and the 75-degree gloss is abruptly changed (increased). This implies that the image in COMPARATIVE EXAMPLE 1 is poorer in in-plane image evenness than the image in EXAMPLE 1. Although the gloss is comparatively low, the image in EXAMPLE 1 has a saturation ratio of 96% in comparison with that in COMPARATIVE EXAMPLE 1, as seen from Table 1. Further, hue angles for colors Y, M, C, B, G, R and Bk have substantially matched values between the image in EXAMPLE 1 and the image in COMPARATIVE EXAMPLE 1.

TABLE 1
Table 1 Color Space Data (recording medium: Xx 75g-paper)

| | | | | | | | | Relative Ratio of C | |
|---|---|---|---|---|---|---|---|---|---|
| | | | | | | | | ((C_{EXAMPLE}/ | |
| EXAMPLE No. | Color | L* | a* | b* | C | h | IDmax | C_{COMPARATIVE EXAMPLE 1}) | Mean Value |
| EXAMPLE 1 | yellow | 98.1 | −11.6 | 87.6 | 88.4 | 107.3 | 1.38 | 1.04 | 0.96 |
| | magenta | 55.8 | 74.0 | −2.5 | 74.1 | 393.9 | 1.34 | 1.00 | |
| | cyan | 57.5 | −28.7 | −52.1 | 59.5 | 265.2 | 1.36 | 1.00 | |
| | blue | 37.0 | 12.8 | −39.6 | 41.6 | 316.7 | 1.25 | 0.87 | |
| | green | 55.0 | −60.6 | 19.0 | 63.5 | 178.8 | 0.88 | 0.90 | |
| | red | 56.1 | 65.2 | 41.5 | 77.3 | 35.7 | 0.67 | 0.94 | |
| | black | 27.4 | 1.0 | 0.7 | 1.2 | 38.7 | 1.49 | | |
| EXAMPLE 2 | yellow | 93.7 | −11.1 | 83.6 | 84.4 | 102.4 | 1.31 | 0.99 | 0.91 |
| | magenta | 53.2 | 70.7 | −2.4 | 70.7 | 376.0 | 1.28 | 0.95 | |
| | cyan | 54.8 | −27.4 | −49.7 | 56.8 | 253.2 | 1.30 | 0.96 | |
| | blue | 35.3 | 12.2 | −37.8 | 39.7 | 302.3 | 1.20 | 0.83 | |
| | green | 52.5 | −57.8 | 18.1 | 60.6 | 170.7 | 0.84 | 0.86 | |
| | red | 53.6 | 62.3 | 39.6 | 73.8 | 34.1 | 0.64 | 0.90 | |
| | black | 26.2 | 0.9 | 0.6 | 1.1 | 37.0 | 1.42 | | |
| EXAMPLE 3 | yellow | 94.6 | −11.2 | 84.4 | 85.2 | 103.4 | 1.33 | 1.00 | 0.92 |
| | magenta | 53.7 | 71.3 | −2.4 | 71.4 | 379.5 | 1.29 | 0.96 | |
| | cyan | 55.4 | −27.7 | −50.2 | 57.3 | 255.6 | 1.31 | 0.96 | |
| | blue | 35.7 | 12.3 | −38.2 | 40.1 | 305.2 | 1.21 | 0.84 | |
| | green | 53.0 | −58.4 | 18.3 | 61.2 | 172.3 | 0.85 | 0.87 | |
| | red | 54.1 | 62.9 | 40.0 | 74.5 | 34.4 | 0.65 | 0.90 | |
| | black | 26.4 | 0.9 | 0.6 | 1.1 | 37.3 | 1.43 | | |
| COMPARATIVE | yellow | 90.3 | −10.8 | 84.6 | 85.2 | 97.3 | 1.32 | 1.00 | 1.00 |
| EXAMPLE 1 | magenta | 48.5 | 74.0 | −5.2 | 74.2 | 356.0 | 1.44 | 1.00 | |
| (LBP5050) | cyan | 49.9 | −27.1 | −52.8 | 59.4 | 242.9 | 1.46 | 1.00 | |
| | blue | 21.9 | 23.8 | −41.7 | 48.0 | 299.8 | 1.48 | 1.00 | |
| | green | 46.3 | −67.6 | 19.3 | 70.3 | 164.1 | 0.90 | 1.00 | |
| | red | 48.0 | 66.8 | 48.1 | 82.4 | 35.8 | 0.65 | 1.00 | |
| | black | 21.0 | 0.8 | 0.6 | 1.0 | 36.8 | 1.48 | | |

TABLE 2
Table 2 Relationship Between Image Density and Gloss

| | | 75°-Gloss | | |
|---|---|---|---|---|
| | | Light | | |
| | | Density | Medium | Deep Density |
| EXAMPLE | Color | Patch | Density Patch | Patch |
| EXAMPLE 1 | yellow | 7.0 | 9.0 | 10.5 |
| | magenta | 7.5 | 8.5 | 11.5 |
| | cyan | 8.0 | 9.0 | 11.0 |
| | blue | 7.5 | 8.5 | 9.5 |
| | green | 8.5 | 9.5 | 9.5 |
| | red | 7.5 | 8.5 | 9.5 |
| | black | 7.5 | 10.0 | 12.0 |
| EXAMPLE 2 | yellow | 7.5 | 10.0 | 12.0 |
| | magenta | 7.5 | 10.5 | 12.5 |
| | cyan | 8.0 | 11.0 | 12.0 |
| | blue | 7.5 | 10.0 | 11.5 |
| | green | 8.5 | 10.5 | 12.5 |
| | red | 7.5 | 9.5 | 12.5 |
| | black | 6.5 | 11.5 | 13.5 |
| EXAMPLE 3 | yellow | 6.5 | 9.0 | 11.0 |
| | magenta | 6.5 | 9.5 | 11.0 |
| | cyan | 7.5 | 9.5 | 10.5 |
| | blue | 7.5 | 9.0 | 9.5 |
| | green | 8.0 | 9.5 | 10.0 |
| | red | 7.5 | 8.5 | 9.5 |
| | black | 6.5 | 11.5 | 12.5 |
| COMPARATIVE | yellow | 7.5 | 11.5 | 35.0 |
| EXAMPLE 1 | magenta | 7.0 | 12.5 | 34.0 |
| (LBP5050) | cyan | 8.5 | 13.5 | 31.5 |
| | blue | 7.5 | 20.0 | 44.5 |
| | green | 9.0 | 18.0 | 45.5 |
| | red | 8.0 | 20.0 | 45.5 |
| | black | 7.0 | 14.0 | 34.0 |

As discussed above, in comparison with COMPARATIVE EXAMPLE 1 (in which maximum power consumption of the heat fixing device during printing is about 300 W as described later), EXAMPLE 1 (in which the power consumption in the full LED turning-on mode is 80 W) succeeds in achieving remarkable energy saving, i.e., a reduction of about 70%, and in realizing the fixing method comparable in image performance.

### EXAMPLE 2

Cyan toner for use in EXAMPLE 2 was prepared by employing the following composition:

| | |
|---|---|
| Styrene n-butyl acrylate copolymer | 200 parts by weight |
| Cyan colorant (C.I. pigment blue 15:3) | 14 parts by weight |
| Polar resin [(terephthalic-propylene oxide | 10 parts by weight |
| denatured bisphenol A) polyester, acid number of | |
| 15, and peak molecular weight of 60000] | |
| Negative charging control agent (dialkylsalicylic | 2 parts by weight |
| metal compound) | |

After sufficiently melting and kneading the above-mentioned composition by an extruder, the composition was mechanically rough-pulverized and a jet stream of rough-pulverized particles was collided against a collision plate for fine pulverization. Further, fine-pulverized powder was classified by an air classifier utilizing the Coanda effect to obtain cyan toner having no regular shape, a weight mean diameter of 8.5 μm, and a number variation coefficient of 29%. After mixing the cyan toner having no regular shape and commercially available fine powder of calcium phosphate with each other by a Henschel mixer, obtained mixed powder was put into a vessel containing water and was further dispersed in the water by using a homomixer. The water temperature was gradually raised and heat treatment was performed on the mixed powder for 3 hours at temperature of 80° C. Thereafter, a diluted hydrochloric acid was added to the vessel to sufficiently dissolve calcium phosphate on the surfaces of cyan toner particles. After filtering, the cyan toner was washed, dried, and then screened by using a 400-messh sieve to remove aggregates, whereby objective cyan toner was obtained. The cyan toner thus obtained had a substantially spherical shape and a circularity of 0.95 as a result of observation using an electron microscope. Also, the obtained cyan toner had a weight mean diameter of 7.7 μm and a number variation coefficient of 28%. In a similar manner, yellow toner, magenta toner, and black toner were obtained with the circularity in a range of 0.95 or more to 0.96 or less. The obtained toners in respective colors were loaded into the modified printer described in EXAMPLE 1 and an unfixed toner image was formed on a recording medium.

As the photopolymerization composition, a stock solution with a viscosity of 200 mPa·s was prepared by mixing 40 parts by weight of dipropylene glycol diacrylate (bifunctional monomer), 40 parts by weight of trimethylolpropane triacrylate (trifunctional monomer), 10 parts by weight of ditrimethylolpropane tetraacrylate (tetrafunctional monomer), and 5 parts by weight of phenylbis-(2,4,6-trimethylbenzoyl)-phosphine oxide (photopolymerization initiator). The prepared stock solution was coated in an amount providing a thickness of 4 μm on the unfixed toner image, which had been formed in advance, by using a simple roll coater disclosed in Japanese Patent Laid-Open No. 2005-254803.

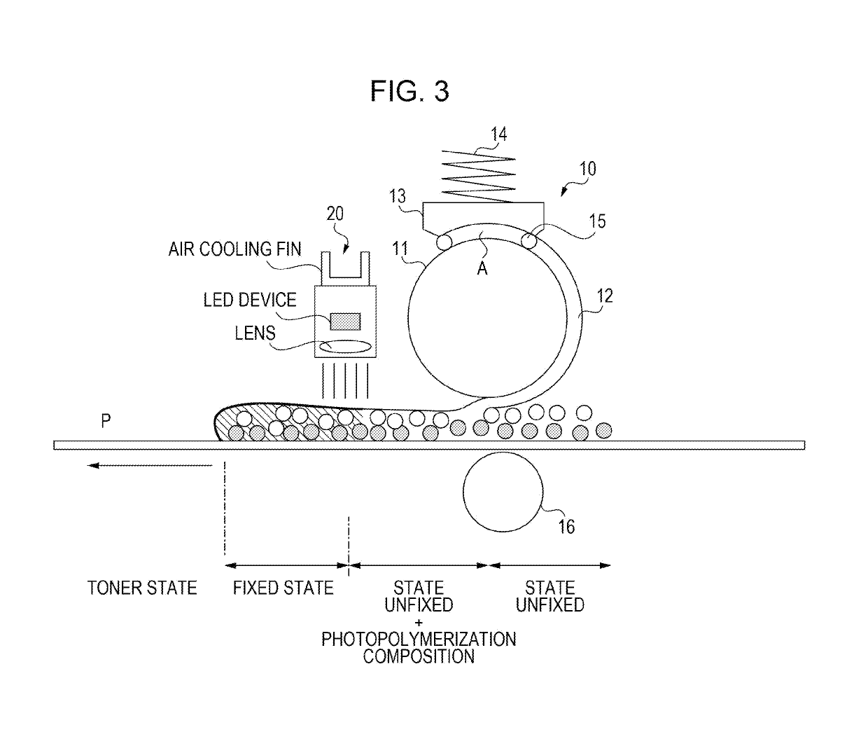

As illustrated in FIG. 3, a roll coater 10 includes a coating roller 11, a space forming base 13 arranged above the coating roller 11, an elastic sealing member 15 having a ring-like shape, and a biasing means 14. With the space forming base 13 biased by the biasing means 14, a space A surrounded by the space forming base 13, the coating roller 11, and the elastic sealing member 15 is defined. A stock solution 12, prepared as described above, is supplied to and held in the space A through a supply hole (not shown), which is provided in the space forming base 13. The stock solution 12 is supplied to the space A by using a pump. The supply/recovery of the stock solution to and from the space A is adjusted by rotating and stopping the coating roller 11. In a state where the coating roller 11 is stopped, the coating roller 11 and the elastic sealing member 15 are in close contact with each other so that, although there is a small gap therebetween, the stock solution 12 is avoided from leaking from the space A by the action of a surface tension of the stock solution 12. When the coating roller 11 is rotated, the stock solution 12 is supplied in a certain amount to the surface of the coating roller 11. At the same time as when a recording medium P including an unfixed toner image formed thereon is conveyed between the coating roller 11 and a backup roller 16, the stock solution 12, i.e., the photopolymerization composition, is coated on the toner image. A light irradiation device 20 is disposed downstream of the roll coater 10. The photopolymerization reaction is quickly progressed and fixing of the toner image is completed by irradiating the photopolymerization composition with light in a similar manner to that described in EXAMPLE 1.

Image evaluation was performed in the same manner as in EXAMPLE 1. A degree of energy saving in comparison with COMPARATIVE EXAMPLE 1 was equal to that obtained in EXAMPLE 1. The photopolymerization reaction was quickly progressed in an exposure time of 0.1 sec set as the light irradiation time, and no problems occurred in fixing of the image. For example, problems regarding the image did not occur with respect to offset (setoff) of the fixed toner image on one recording medium to the rear side of another one and a rubbing (friction) smear of the fixed toner image when many recording mediums were stacked in a tray. Evaluation results of the obtained images are listed in Tables 1 and 2. As seen from Table 1, the saturation ratio is 91% in comparison with the image sample formed in COMPARATIVE EXAMPLE 1. A further merit resides in that, since the toner in EXAMPLE 2 contains no parting agent, a density reduction (from 1.4 to 1.2) in an endurance test of printing 10000 sheets of the recording medium (at 32° C. and 80%RH) is smaller than that (from 1.4 to 1.0) in the related art.

### EXAMPLE 3

In EXAMPLE 3, the same toner, the same image forming apparatus, and the same image evaluation method as those in EXAMPLE 1 were employed except for the light irradiation device and the photopolymerization composition. As the photopolymerization composition, a stock solution with a viscosity of 40 mPa·s was prepared by mixing 80 parts by weight of tripropylene glycol diacrylate (bifunctional monomer), 10 parts by weight of trimethylolpropane triacrylate (trifunctional monomer), 1 part by weight of ditrimethylolpropane tetraacrylate (made by Sartomer Company: tetrafunctional monomer), and 5 parts by weight of phenylbis-(2,4,6-trimethylbenzoyl)-phosphine oxide (made by Ciba-Geigy Limited, photopolymerization initiator). The prepared stock solution was loaded in the large-size IJ machine UJF-605cII made by Mimaki Engineering Co., Ltd., and was coated in a heated state in an amount providing a thickness of 6 μm on the unfixed toner image which had been formed in advance. In the light irradiation device in EXAMPLE 3, OLED-UV light having an emission half-width of 42 nm and a peak wavelength of 380 nm was utilized by employing, as the luminescent material, the triazole-based derivative, which had been proposed in “Singaku Gihou” (The Technical Report of the Proceeding of the Institute of Electronics, Information and Communication Engineers), vol 107, no 552, p5-8 (2008) in combination with CBP. The UV irradiation intensity was set to cover an irradiation area of the letter size width (215.9 mm) with the intensity of 650 mW/cm². A surface emitting device was cut with a width of 6 mm in the sub-scanning direction and was encapsulated by using a resin, whereby a parallelepiped light emitting unit was obtained. The power consumption in the full turning-on mode was 135 W and a remarkable reduction of about 55% in energy consumption was realized in comparison with the maximum energy consumption of the heat fixing device in COMPARATIVE EXAMPLE 1. Evaluation results of the obtained images are listed in Tables 1 and 2. As seen from Table 1, the saturation ratio is 92% in comparison with that in COMPARATIVE EXAMPLE 1.

### EXAMPLE 4

In EXAMPLE 4, an unfixed toner image was formed on a recording medium by employing the image forming apparatus used in EXAMPLE 1 and toner prepared using the following composition:

| | |
|---|---|
| Styrene-n-butyl acrylate copolymer | 200 parts by weight |
| (Mw 70000 and Mn 20000) | |
| Cyan colorant (C.I. pigment blue 15:3) | 14 parts by weight |
| Ethylene-propylene copolymer wax | 3 parts by weight |
| Polar resin [(terephthalic-propylene oxide | 10 parts by weight |
| denatured bisphenol A) polyester, acid number | |
| of 15, and peak molecular weight of 60000] | |
| Negative charging control agent (dialkylsalicylic | 2 parts by weight |
| metal compound) | |

After sufficiently melting and kneading the above-mentioned composition by an extruder, the composition was mechanically rough-pulverized and a jet stream of rough-pulverized particles was collided against a collision plate for fine pulverization. Further, fine-pulverized powder was classified by an air classifier utilizing the Coanda effect to obtain cyan toner having no regular shape, a weight mean of 8.5 μm, a number variation coefficient of 37%, and a circularity of 0.88. In a similar manner, yellow toner, magenta toner, and black toner were obtained by using, as colorants, C.I. pigment yellow 17, C.I. pigment red 202, and graft carbon black, respectively. As in EXAMPLE 1, an image forming apparatus was prepared as the modified version obtained by removing the fixing device in the LBP5050. The one-component developer prepared as described for each color was put into a developing device, and an unfixed toner image was formed on the recording medium. The photopolymerization composition, the light irradiation device, and the image evaluation method used in EXAMPLE 4 were also the same as those used in EXAMPLE 1.

An exposure of the photopolymerization composition was performed for the light irradiation time of 0.15 sec. Thus, the progress of the photopolymerization reaction took a time 1.5 times that taken in EXAMPLE 1. In other words, to complete the fixing in the same time as that (0.1 sec) in EXAMPLE 1, it was required to increase the maximum power consumption of the LED by 1.5 times (i.e., to 120 W). Nevertheless, a reduction of about 60% in energy consumption was realized in comparison with the maximum energy consumption (about 300 W) of the heat fixing device in COMPARATIVE EXAMPLE 1. No problems occurred in regard of fixing performance. For example, problems regarding the image did not occur with respect to offset (setoff) of the fixed toner image on one recording medium to the rear side of another one and a rubbing (friction) smear of the fixed toner image when many recording mediums were stacked in a tray.

### EXAMPLE 5

EXAMPLE 5 was implemented in the same manner as in EXAMPLE 1 except for changing the photopolymerization composition and the light irradiation conditions. As the photopolymerization composition, a stock solution with a viscosity of 17 mPa·s was prepared by mixing 85 parts by weight of dipropylene glycol diacrylate (bifunctional monomer), 10 parts by weight of trimethylolpropane ethoxytriacrylate (trifunctional monomer), and 5 parts by weight of phenylbis-(2,4,6-trimethylbenzoyl)-phosphine oxide (photopolymerization initiator). An exposure of the photopolymerization composition was performed for the light irradiation time of 0.2 sec. Thus, the progress of the photopolymerization reaction took a time twice that taken in EXAMPLE 1. In other words, to complete the fixing in the same time as that (0.1 sec) in EXAMPLE 1, it was required to increase the maximum power consumption of the LED twice (i.e., to 160 W). Nevertheless, a reduction of about 45% in energy consumption was realized in comparison with the maximum energy consumption (about 300 W) of the heat fixing device in COMPARATIVE EXAMPLE 1. No problems occurred in regard of fixing performance. For example, problems regarding the image did not occur with respect to offset (setoff) of the fixed toner image on one recording medium to the rear side of another one and a rubbing (friction) smear of the fixed toner image when many recording mediums were stacked in a tray.

COMPARATIVE EXAMPLE 1

An image sample was output by using the LBP5050 equipped with the regular heat fixing device. Toner loaded in the LBP5050 contained a parting agent. Further, the maximum power consumption of the heat fixing device in the printing operation of the LBP5050 (i.e., during heat fixing of an unfixed toner image) was about 300 W. Evaluation results of images obtained after the heat fixing are shown in Table 1 and 2 and FIGS. 1 and 2.

Since a fixing step is performed with a photopolymerization reaction without utilizing heat, remarkable energy saving can be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A toner image fixing method comprises the steps of coating a photopolymerization composition on an unfixed toner image formed on a recording medium, and then irradiating the photopolymerization composition with light, which does not have an emission wavelength band in a far infrared range and which has a maximum emission wavelength in a range of 360 nm or longer to 420 nm or shorter, by using a light emitting diode or an organic EL element, thereby curing the photopolymerization composition with a photopolymerization reaction and fixing the unfixed toner image to the recording medium.

2. The toner image fixing method according to claim 1, wherein the photopolymerization composition contains a tetra or more multifunctional acryl monomer.

3. The toner image fixing method according to claim 1, wherein the toner has a circularity of 0.95 or more to 1.00 or less.

4. The toner image fixing method according to claim 1, wherein the toner does not contain a parting agent.

5. A toner image fixing method comprises the steps of preparing a recording medium including an unfixed toner image of which surface is coated with a photopolymerization composition, and irradiating the recording medium with light, which does not substantially have an emission band in a far infrared range and which has a maximum emission wavelength in a range of 360 nm or longer to 420 nm or shorter, thereby causing the photopolymerization composition to develop a photopolymerization reaction and fixing the unfixed toner image to the recording medium.
